(19) United States
(12) Patent Application Publication
(10) Pub. No.: US 2019/0212445 A1
(43) Pub. Date: Jul. 11, 2019

(54) LASER DISTANCE SENSING USING PRIOR MEASUREMENT INFORMATION

(71) Applicant: Integrated Device Technology, Inc., San Jose, CA (US)

(72) Inventor: Cheng Wen HSIAO, San Jose, CA (US)

(73) Assignee: Integrated Device Technology, Inc., San Jose, CA (US)

(21) Appl. No.: 15/867,553

(22) Filed: Jan. 10, 2018

(51) Int. Cl. G01S 17/08

(52) U.S. Cl. CPC G01S 17/08

(57) ABSTRACT

A laser distance sensor (LDS) performs multiple measurement attempts with different values of operating parameters, e.g. of laser power gain (G_{L}) or received light amplifier gain (G_{TIA}). The parameter values, and the order of values for different measurement attempts, are determined from analysis of prior measurement data. Such data may include parameter values used in prior satisfactory measurements. The parameter values, the order indication, and other measurement information are stored by the LDS for use in subsequent measurements. Machine learning is performed to analyze stored data and determine the best parameter values and order for the current measurement.

### BACKGROUND OF THE INVENTION

The present invention relates to laser distance sensors, such as can be used in lidars (light detection and ranging devices), robots, drones, or other types of devices.

A laser distance sensor (LDS) determines the distance to an object by emitting laser light and sensing the reflected light. For example, in the time-of-flight method (TOF), the LDS emits a laser beam towards the object, senses the reflected light, and measures the time T that elapses between emitting the laser beam and sensing the reflected light. The distance D is then calculated as

D=T*c/2 (1)

where c is the speed of light.

The measurement reliability depends on the LDS operating parameters such as laser power and the gain of the LDS electronics. The optimal parameter values may depend on the object's optical properties (reflectivity, surface smoothness, etc.); environmental factors such as lighting and air pollution; whether the distance range is large, e.g. on the order of kilometers or millimeters; etc. For example, if the distance is large, the laser power should be increased. Also, the LDS electronics that processes the reflected light may be adjusted for higher gain. However, excessive laser power or gain overpowers the LDS sensor and pertinent electronics and causes undesirable optical and electrical noise. Therefore, the LDS may repeat the same measurement multiple times with different parameter values until a satisfactory measurement is obtained.

FIG. 1 illustrates an exemplary LDS device 110. Laser source 120 can be a laser diode or some other type, for example an IR (infrared) diode. Laser 120 emits a laser beam 124 under control of driver 128. Driver 128 is an electronic circuit controlled by computer processor 132 (e.g. ARM M3 or some other type). The processor operates in conjunction with read/write random access memory (RAM) 136.

Reflected light and other incoming light is sensed by sensor 140 (possibly a photodiode, e.g. avalanche photodiode), which generates an electric current signal proportional to the received light intensity. The current is converted to a voltage Vr by transimpedance amplifier (TIA) 144. This voltage Vr (“return voltage” or “return signal”), shown in FIG. 2, is processed by comparator 148, which can be an analogue device or a digital signal processor for example. Comparator 148 may compare the voltage to some threshold voltage Vth (FIG. 2) to generate a signal tₛ indicating the moment of time when the Vth threshold has been reliably reached. See Sami Kurtti, “Integrated Receiver Channel and Timing Discrimination Circuits for a Pulsed Time-of-Flight Laser Rangefinder”, University of Oulu, 2012 (Academic Dissertation, Faculty of Technology, Department of Electrical Engineering), incorporated herein by reference.

The comparator's output signal iₛ is provided to time-to-digital converter (TDC) 160. TDC 160 also receives, from driver 128 or processor 132, a Start signal asserted when the light beam 124 was emitted. TDC 160 outputs a digital signal indicating the time from the Start assertion to the comparator 148 indication iₛ of the moment of time when the threshold voltage Vth has been reached. TDC 160 and/or processor 132 then determine the distance to the object per equation (1).

FIG. 2 is a timing diagram of an exemplary Vr waveform. Ideally, the light pulse emitted by laser 120 should produce a voltage pulse (210) at the TIA output, and this voltage pulse should cross the Vth threshold at an easily recognizable moment of time. In practice however, Vr can be distorted by optical and electrical noise as explained above, and the voltage pulse may be hard to detect, or the moment of crossing the Vth threshold may be difficult to correlate to the time of receipt of the reflected light. The voltage pulse may be strengthened by increasing the gain G_{TIA} of TIA 144 and/or the laser power emitted by laser 120, but such techniques also increase noise and/or overwhelm the electronics in the receive channel (including sensor 140, TIA 144, and comparator 148). In addition, high laser power creates health and safety hazards and energy waste.

To improve measurement reliability, multiple measurement attempts are performed with different parameter values until a good voltage pulse is obtained at the TIA output, as illustrated in the flowchart of FIG. 3. Specifically, at step 310, processor 132 gets initial, factory-defined parameter values for the laser power and TIA gain. The TIA gain is shown as G_{TIA}. The laser power is expressed as a gain parameter G_{L} for driver 128.

The initial G_{L} and G_{TIA} values may be obtained by processor 132 from a one-time programmable (OTP) memory 180, as shown at 184 in FIG. 1. These values are factory-defined, i.e. pre-stored in memory 180 at the manufacturing time. For example, suppose the laser driver gain G_{L} can have any of three possible values, designated herein for simplicity as Low, Medium, High; and TIA gain G_{TIA} can have any of three possible values, designated as Small, Middle, Large. The initial, factory-defined values in memory 180 may be the lowest settings: Low for G_{L} and Small for G_{TIA}.

Additionally or alternatively, the initial values may be based on user entry. For example, the LDS may include user interface (not shown), e.g. a keyboard or buttons, allowing the user to specify some settings, such as:
the distance to be measured: Large, Medium, or Small;
Indoor or Outdoor use;
object motion: Spinning or not;

and possibly other types of information. Memory 180 may store a pair of initial (G_{L}, G_{TIA}) values for each set of user settings. For example, if the distance setting is Large, the use is Outdoor, and the object is Spinning, then the initial G_{L} may be High, and the initial G_{TIA} may be Middle. Other variations are possible. At step 310, processor 132 determines the initial (G_{L}, G_{TIA}) values corresponding to the current user settings.

Processor 132 sends the initial G_{L} value to driver 128, and sends the initial G_{TIA} value to TIA 144.

At step 320, driver 128 drives the laser 120 to generate a laser pulse corresponding to the G_{L} value. For example, if laser 120 is a laser diode, driver 128 generates the corresponding voltage and/or current pulse across the diode.

At the same time, processor 132 or driver 128 generates the Start signal for TDC 160, and the TDC starts measuring time.

Sensor 140 generates electric current representative of the incoming light. At step 330, sensor 140 receives the reflected laser light and generates the corresponding current. TIA 144 converts this current to voltage, producing a voltage pulse 210 in the Vr waveform.

Comparator 148 analyzes the Vr waveform, and sends a signal to processor 132 with information on the waveform quality. The information may indicate the presence of pulse 210, the pulse height (amplitude), the width at half the height, whether the pulse is detected within a predefined maximum time of the Start assertion, the average slope of the pulse rising edge, etc. Processor 132 records this information in memory 136 and/or in log 178 in memory 180 (step 330A).

Also at step 330, comparator 148 informs TDC 160, via the iₛ signal, of receipt of pulse 210. For example, the iₛ signal may be asserted when the Vr leading edge crosses the Vth threshold, or the iₛ signal may indicate the pulse receipt in some other way. See Sami Kurtti's dissertation cited above. In response, TDC 160 outputs a digital signal indicating the time T from the Start assertion to the time indicated by the iₛ signal. The distance D may then be calculated by TDC 160 and/or processor 132 in digital form per equation (1) if the measurement is satisfactory.

Steps 320 and 330 may be repeated a number of times with the same G_{L} and G_{TIA} values, and the resulting T or D values may be averaged to provide the distance measurement for these G_{L} and G_{TIA} values.

At step 334, based on the information from comparator 148, processor 132 determines whether the Vr signal integrity is satisfactory, i.e. whether the pulse 210 is reliable. For example, processor 132 may decide that the Vr signal is satisfactory if the pulse 210 amplitude is at least some predefined, minimal value; the rising edge's average slope has at least some predefined, minimal magnitude; and the pulse is received within some predefined time interval after the Start signal assertion.

If the Vr waveform is satisfactory, the distance D is output at step 340, and the process terminates (step 350).

Otherwise (step 354), processor 132 determines whether the current G_{L}, G_{TIA} values are the last value pair, i.e. all the other value pairs have been tried in the measurement process. If so (step 358), processor 132 determines the best Vr waveform from the data written at step 330A (step 358), and outputs the corresponding distance D at step 340. For example, the best waveform may be determined as the one having the largest average rising edge slope for pulse 210, or the largest amplitude, or in some other manner. The process then terminates at step 350. Alternatively, the processor may output an error indication if the distance D cannot be reliably determined from the waveforms obtained in the current measurement process.

Returning to step 354, if another parameter value pair is available, such value pair is determined (step 360), and the next measurement iteration is performed starting at step 320.

At step 360, the new G_{L} and G_{TIA} values are chosen according to a predefined sequence as follows. At first, G_{L} is unchanged, and the next higher G_{TIA} value is chosen incrementally. When all the G_{TIA} values have been exhausted, then the next G_{L} value is incrementally chosen, and different values are tried again in incremental order for the new G_{L} value. Thus, the parameter values may be tried in the following order:
At step 310: G_{L}=Low, G_{TIA}=Small.
If the measurement is unsatisfactory (as determined at 334), then at step 360 the following values are chosen: G_{L}=Low, G_{TIA}=Middle, and the measurement is repeated.
If the new measurement is unsatisfactory, then at step 360 the following values are chosen: G_{L}=Low, G_{TIA}=Large.
If the new measurement is still unsatisfactory, then at step 360 the following values are chosen: G_{L}=Medium, G_{TIA}=Small.
If the measurement is still unsatisfactory, then at next step 360 the following values are chosen: G_{L}=Medium, G_{TIA}=Middle.

And so on.

An improved process is desired which could produce a satisfactory measurement faster and with less power consumption. This is especially useful for real time, battery-powered applications such as drones, self-driving cars, etc., though the invention is not limited to such applications.

### SUMMARY

This section summarizes some features of the invention. Other features may be described in the subsequent sections. The invention is defined by the appended claims, which are incorporated into this section by reference.

In some embodiments, LDS parameter values are determined using prior measurement data. For example, in some embodiments, the LDS of FIGS. 1 and 3 is modified to determine the G_{L} and G_{TIA} parameter values at step 310 and/or 360 using prior measurement data, possibly the data in log 178. The parameter selection (at step 310 or 360 for example) may use machine learning techniques. In some embodiments, the parameter values at step 310 are chosen from log 178 as the most recent values that provided a satisfactory prior measurement. Or the parameters values can be chosen based on some weighting of the prior values stored in log 178. In some embodiments, the weight of a parameter value (e.g. G_{L} or G_{TIA}), or of a combination of values of different parameters (e.g. of a pair (G_{L}, G_{TIA})), can be defined as the percentage of satisfactory prior measurements obtained using that particular value or combination relative to the total number of satisfactory prior measurements. In some embodiments, greater weight is given to more recent values or combinations providing satisfactory measurements.

The invention is not limited to the features and advantages described above except as defined by the appended claims.

### BRIEF DESCRIPTION OF THE DRAWINGS

FIG. 1 is a block diagram representing a laser distance sensor (LDS) according to prior art.

FIG. 2 is a timing diagram of a signal generated by an LDS according to prior art and also according to some embodiments of the present invention.

FIG. 3 is a flowchart of LDS operation according to prior art.

FIG. 4 is a flowchart of LDS operation according to some embodiments of the present invention.

FIG. 5 is a block diagram representing a laser distance sensor (LDS) according to some embodiments of the present invention.

### DESCRIPTION OF SOME EMBODIMENTS

The embodiments described in this section illustrate but do not limit the invention. The invention is defined by the appended claims.

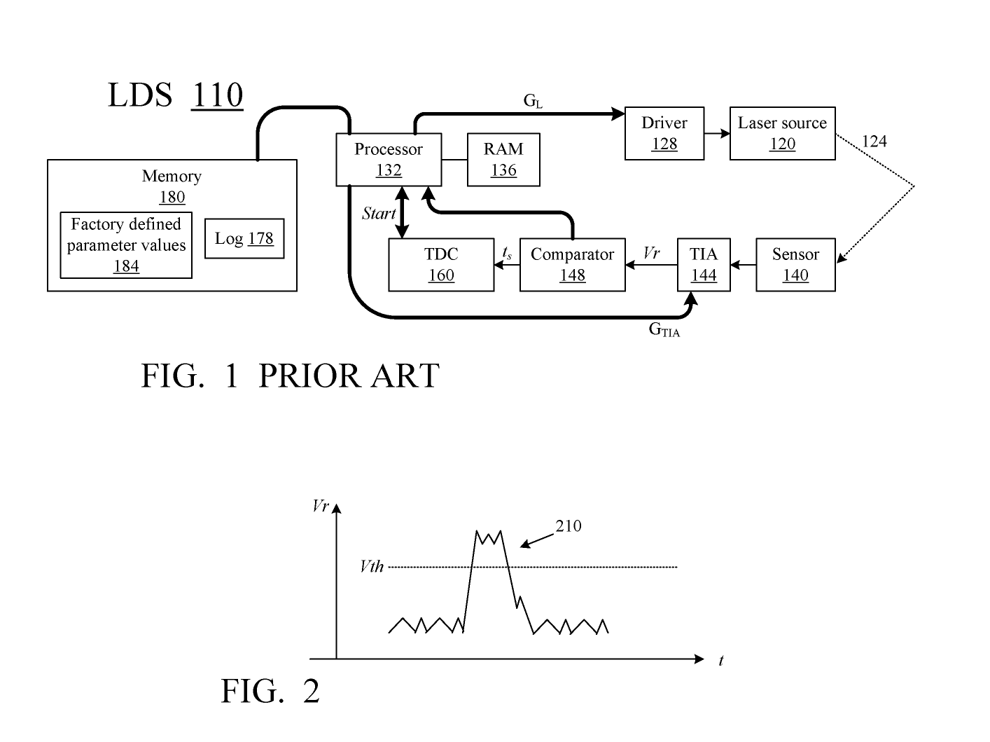

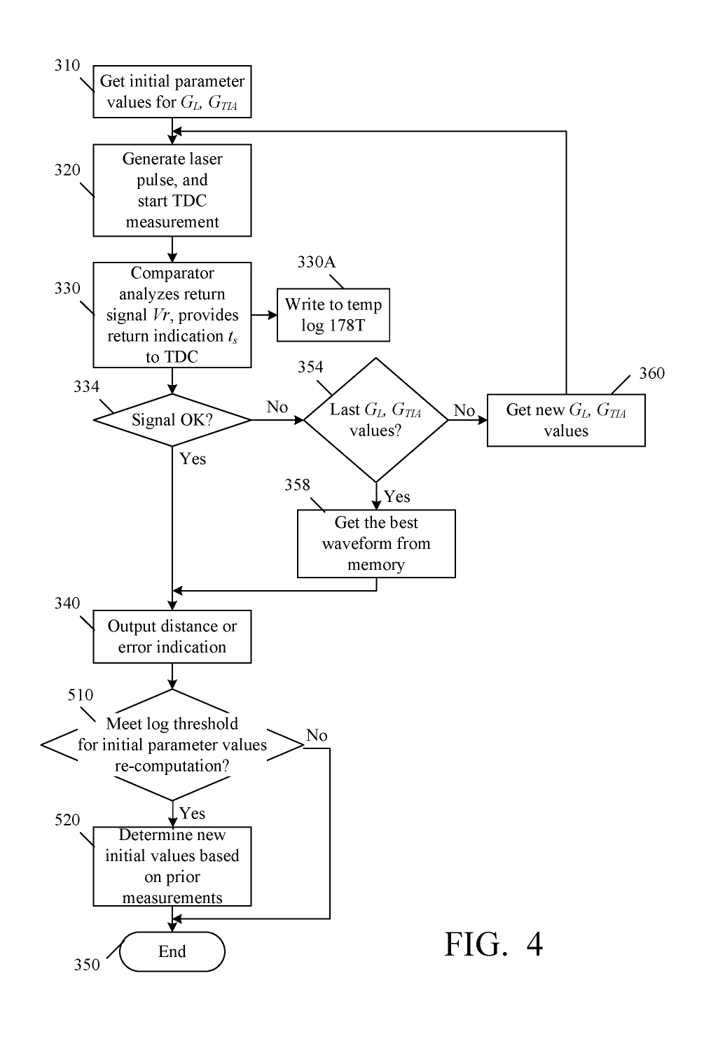

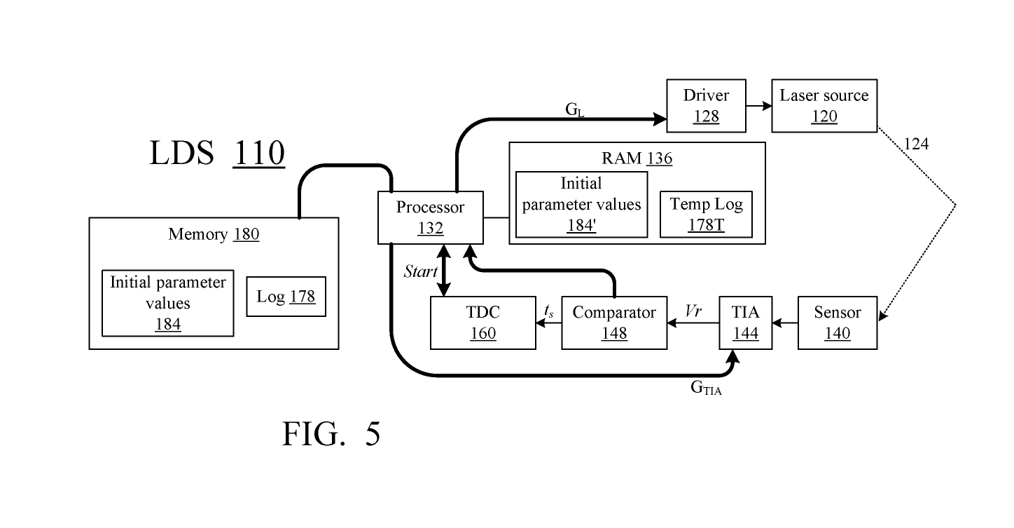

FIG. 4 illustrates LDS operation according to some embodiments of the present invention. For ease of illustration, the LDS is assumed to have the structure of FIG. 5, but other LDS architectures can also be used. In some embodiments, the LDS of FIG. 5 is identical to FIG. 1, except that processor 132 operates differently as described below. The processor can be programmed, for example, by software (not shown) stored in memory 180 and/or 136.

At step 310 of FIG. 4, processor 132 obtains initial parameter values from OTP memory 180 or RAM 136. For example, the initial values may be factory defined, and stored in area 184 of OTP 180 or area 184′ of RAM 136. Or the initial values may be determined using prior measurements as described below, and stored in area 184 and/or 184′.

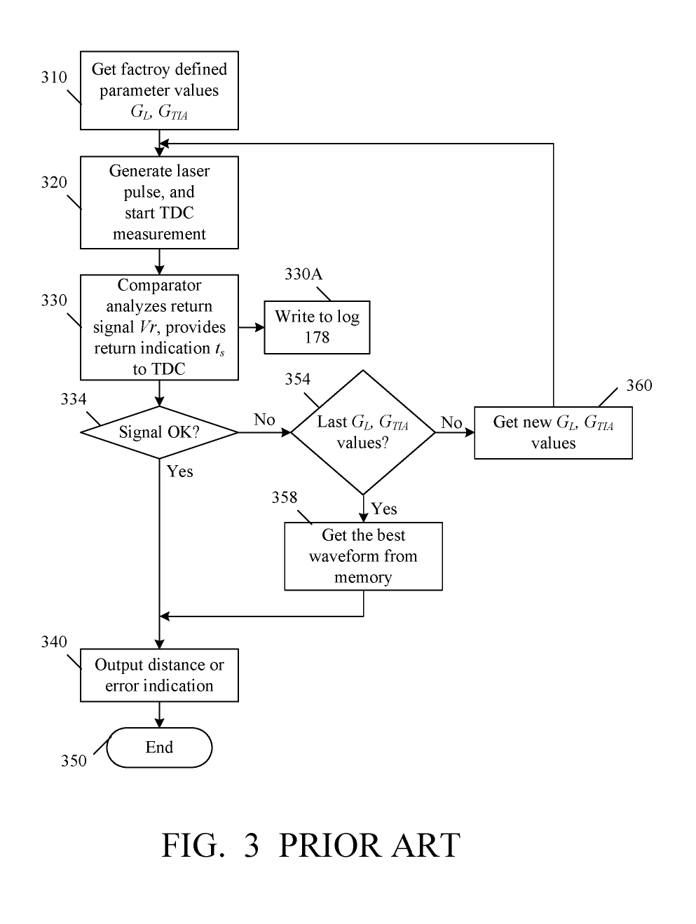

These values are used at step 320, as in FIG. 3: a laser pulse is generated, and TDC 160 starts the time measurement.

Step 330 is also performed as in FIG. 3. Distance D can be generated as in FIG. 3.

Step 330A can be performed as in FIG. 3, and/or the waveform data can be written to a temporary log 178T in RAM 136.

Steps 334, 354, 358, 340 are performed as in FIG. 3.

In some embodiments, step 360 is performed as in FIG. 3.

After step 340, processor 132 determines, at step 510, whether new initial parameter values should be determined based on prior measurements (including the current measurement). In some embodiments, step 510 also determines the order of values for subsequent iterations of step 360. For example, the initial, factory-defined order can be incremental as described above in connection with FIG. 3; but step 510 may indicate the decremental order as superior, i.e. as more likely to quickly lead to a satisfactory measurement.

In this embodiment, the new initial parameter values and/or order are not determined after every measurement attempt, but are determined after a predefined number of measurements (e.g. 1000 or more) in log 178T, or after a predefined threshold of data size in log 178T has been reached. The predefined number of measurements may be a predefined number of completed measurements (i.e. reaching the step 350), or a predefined number of measurement attempts (i.e. iterations of the process of FIG. 4).

If step 510 indicates that the new initial parameter values and/or order should be computed, e.g. some measurement or data threshold in log 178T has been reached, then (step 520) prior measurement data in log 178T and/or 178 are used to determine the new initial parameter values and/or order. These initial parameter values and/or order are recorded in memory area 184 and/or 184′, for use in the next measurement at steps 310 and 360. Then temporary log 178T is erased.

Otherwise (if the log 178T threshold has not been reached), step 520 is skipped.

The process then terminates at step 350.

In some embodiments, step 520 is performed as follows. For each G_{L} value in log 178T and/or 178, a corresponding weight is determined, which is the percentage of all the satisfactory prior measurements (completed measurements) with that value relative to the number of all satisfactory prior measurements in log 178T and/or 178 respectively. The G_{L} value is chosen as the value having the maximum weight.

For example, suppose that in prior satisfactory measurements recorded in log 178 or 178T, the “Large” G_{L} value was used in 80% of the measurements, the Medium value in 20%, and the Small value in 0%. Then the Large G_{L} value is chosen.

In some embodiments, this process takes into account only the measurements corresponding to the current user settings. For example, if the current settings are Indoor use, then only the Indoor use measurements in log 178 and/or 178T are taken into account.

The G_{TIA} value is selected in the same or some other way, taking into account prior measurement data in log 178 and/or 178T.

In some embodiments, only one of the G_{L} and G_{TIA} values is selected based on analysis (e.g. weighting) of prior measurement data, while the other value is selected as in FIG. 3 or in some other way.

In some embodiments, the LDS analyzes pairs of the G_{L} and G_{TIA} values together rather than each value separately. For example, in some embodiments, for each pair of values, a corresponding weight is determined, which is the percentage of all the satisfactory prior completed measurements obtained with that pair of values relative to the number of all satisfactory prior measurements. The new initial pair of values is chosen as the pair with the maximum weight.

Other techniques can also be used, based on machine learning analysis of the prior measurement data in log 178 and/or 178T for example. Thus, in some embodiments, at step 520, machine learning techniques establish statistical criteria for use in parameter value selection. For example, statistical analysis may determine that the fastest way to reach a good Vr waveform is to change one or both of the G_{L} and G_{TIA} values decrementally rather than incrementally. For example, suppose the factory-defined parameter value sequence for step 360, for some user settings, is:

G_{L}=A, B, C;

G_{TIA}=a, b, c;

and the initial values are G_{L}=A; G_{TIA}=a.

At step 520, machine learning applied to the prior measurements for these user settings may show that the fasted way to arrive at a good waveform at step 360 is as follows:

G_{L}=C, B, A;

G_{TIA}=b, a, c;

and therefore the best initial values (for step 310) are G_{L}=C; G_{TIA}=b.

In some embodiments, step 510 is omitted, and step 520 is performed after each completed measurement. In other embodiments, step 510 is present to cause step 520 to be performed within a completed measurement, after some given number of iterations.

Other aspects of the LDS operation may or may not be as in FIG. 3.

The invention is not limited to the features described above. Further, in some embodiments, some or all of the LDS circuits (e.g. processor 132) may include optical circuitry.

Some embodiments are defined by the following numbered clauses:

Clause 1. A method for measuring a distance by a laser distance sensor (LDS) operating according to one or more operating parameters, the method comprising:

storing, in a memory, prior measurement data comprising information on prior measurement parameter values that are values of the one or more operating parameters in one or more prior measurements; and

measuring the distance by the LDS using the prior measurement data.

2. The method of clause 1 wherein said measuring comprises:

(1) performing a signal acquisition by the LDS to obtain a signal representing light received by the LDS (for example, in some embodiments, the signal may include the output of sensor 140 and/or TIA 144 and/or comparator148 and/or TDC 160 and/or the Tor D value of equation (1)), the signal acquisition comprising:

obtaining a first set of one or more parameter values of the one or more operating parameters (for example, this can be step 310 or 360 or 520); and

operating the LDS with the first set of parameter values, said operating comprising (i) emitting light by the LDS, and (ii) processing received light by the LDS to obtain the signal;

(2) analyzing the signal to determine if the signal meets one or more predefined criteria;

(3) if the signal does not meet the one or more predefined criteria, then performing the signal acquisition again by the LDS to obtain the signal representing light received by the LDS (e.g. at step 360 or 520), the signal acquisition comprising:

obtaining a second set of one or more parameter values of the one or more operating parameters, the second set being different from the first set; and

operating the LDS with the second set of parameter values, the operating comprising (i) emitting light by the LDS, and (ii) processing received light by the LDS to obtain the signal;

wherein at least one of the first and second sets is obtained using the prior measurement data.

3. The method of clause 2 wherein:

the prior measurement data comprise information on user settings in prior measurements; and

said at least one of the first and second sets is obtained using only those prior measurement data that correspond to prior measurements performed with the same user settings as current user settings.

4. The method of clause 3 wherein the current user settings comprise an indication of how large the distance to be measured is.

5. The method of clause 3 or 4 wherein the current user settings specify whether the measuring is to be performed indoors or outdoors.

6. The method of clause 3, 4, or 5 wherein the user settings specify whether the distance to be measured is the distance to a spinning object.

7. The method of clause 2, 3, 4, 5, or 6, wherein at least one parameter value in at least one of the first and second sets affects a power of the light emitted by the LDS.

8. The method of clause 2, 3, 4, 5, 6, or 7, wherein at least one parameter value in at least one of the first and second sets affects a gain in processing the light received by the LDS.

9. The method of clause 2, 3, 4, 5, 6, 7, or 8, wherein the signal comprises an electrical signal.

10. The method of clause 2, 3, 4, 5, 6, 7, 8, or 9, wherein the signal comprises an optical signal.

11. A laser distance sensor (LDS) for measuring distances by operating according to one or more operating parameters, the LDS comprising:

a laser source;

a light sensor; and

a module for obtaining one or more parameter values of the one or more operating parameters, and for controlling the light source and the light sensor to measure a distance in accordance with the one or more parameter values;

wherein the module is operable to store, in a memory, prior measurement data comprising information on prior measurement parameter values that are values of the one or more operating parameters in one or more prior measurements; and

the module is operable to measure the distance using the prior measurement data.

12. The LDS of clause 11 wherein the module is operable to cause the LDS to:

(1) perform a signal acquisition to obtain a signal representing light received by the light sensor, the signal acquisition comprising:

obtaining a first set of one or more parameter values of the one or more operating parameters; and

operating the LDS with the first set of parameter values, said operating comprising (i) emitting light by the laser source, and (ii) processing light received by the sensor to obtain the signal;

(2) analyze the signal to determine if the signal meets one or more predefined criteria;

(3) if the signal does not meet the one or more predefined criteria, then perform the signal acquisition again to obtain the signal representing light received by the light sensor, the signal acquisition comprising:

obtaining a second set of one or more parameter values of the one or more operating parameters, the second set being different from the first set; and

operating the LDS with the second set of parameter values, the operating comprising (i) emitting light by the laser source, and (ii) processing light received by the sensor to obtain the signal;

wherein at least one of the first and second sets is obtained using the prior measurement data.

13. The LDS of clause 12 wherein:

the prior measurement data comprise information on user settings in prior measurements; and

said at least one of the first and second sets is obtained using only those prior measurement data that correspond to prior measurements performed with the same user settings as current user settings.

14. The LDS of clause 13 wherein the current user settings comprise an indication of how large the distance to be measured is.

15. The LDS of clause 13 or 14 wherein the current user settings specify whether the measuring is to be performed indoors or outdoors.

16. The LDS of clause 13, 14, or 15, wherein the user settings specify whether the distance to be measured is the distance to a spinning object.

17. The LDS of any one of clauses 14 through 16, wherein at least one parameter value in at least one of the first and second sets affects a power of the light emitted by the LDS.

18. The LDS of any one of clauses 12 through 17, wherein at least one parameter value in at least one of the first and second sets affects a gain in processing the light received by the LDS.

19. The LDS of any one of clauses 12 through 18, wherein the signal comprises an electrical signal.

20. The LDS of any one of clauses 12 through 19, wherein the signal comprises an optical signal.

The invention is not limited to the LDS structure of FIG. 1 or other features described above, except as defined by the appended claims.

1. A method for measuring a distance by a laser distance sensor (LDS) operating according to one or more operating parameters, the method comprising:
storing, in a memory, prior measurement data comprising information on prior measurement parameter values that are values of the one or more operating parameters in one or more prior measurements; and
measuring the distance by the LDS using the prior measurement data.

2. The method of claim 1 wherein said measuring comprises:
(1) performing a signal acquisition by the LDS to obtain a signal representing light received by the LDS, the signal acquisition comprising:
obtaining a first set of one or more parameter values of the one or more operating parameters; and
operating the LDS with the first set of parameter values, said operating comprising (i) emitting light by the LDS, and (ii) processing received light by the LDS to obtain the signal;
(2) analyzing the signal to determine if the signal meets one or more predefined criteria;
(3) if the signal does not meet the one or more predefined criteria, then performing the signal acquisition again by the LDS to obtain the signal representing light received by the LDS, the signal acquisition comprising:
obtaining a second set of one or more parameter values of the one or more operating parameters, the second set being different from the first set; and
operating the LDS with the second set of parameter values, the operating comprising (i) emitting light by the LDS, and (ii) processing received light by the LDS to obtain the signal;
wherein at least one of the first and second sets is obtained using the prior measurement data.

3. The method of claim 2 wherein:
the prior measurement data comprise information on user settings in prior measurements; and
said at least one of the first and second sets is obtained using only those prior measurement data that correspond to prior measurements performed with the same user settings as current user settings.

4. The method of claim 3 wherein the current user settings comprise an indication of how large the distance to be measured is.

5. The method of claim 3 wherein the current user settings specify whether the measuring is to be performed indoors or outdoors.

6. The method of claim 3 wherein the user settings specify whether the distance to be measured is the distance to a spinning object.

7. The method of claim 2 wherein at least one parameter value in at least one of the first and second sets affects a power of the light emitted by the LDS.

8. The method of claim 2 wherein at least one parameter value in at least one of the first and second sets affects a gain in processing the light received by the LDS.

9. The method of claim 2 wherein the signal comprises an electrical signal.

10. The method of claim 2 wherein the signal comprises an optical signal.

11. A laser distance sensor (LDS) for measuring distances by operating according to one or more operating parameters, the LDS comprising:
a laser source;
a light sensor; and
a module for obtaining one or more parameter values of the one or more operating parameters, and for controlling the light source and the light sensor to measure a distance in accordance with the one or more parameter values;
wherein the module is operable to store, in a memory, prior measurement data comprising information on prior measurement parameter values that are values of the one or more operating parameters in one or more prior measurements; and
the module is operable to measure the distance using the prior measurement data.

12. The LDS of claim 11 wherein the module is operable to cause the LDS to:
(1) perform a signal acquisition to obtain a signal representing light received by the light sensor, the signal acquisition comprising:
obtaining a first set of one or more parameter values of the one or more operating parameters; and
operating the LDS with the first set of parameter values, said operating comprising (i) emitting light by the laser source, and (ii) processing light received by the sensor to obtain the signal;
(2) analyze the signal to determine if the signal meets one or more predefined criteria;
(3) if the signal does not meet the one or more predefined criteria, then perform the signal acquisition again to obtain the signal representing light received by the light sensor, the signal acquisition comprising:
obtaining a second set of one or more parameter values of the one or more operating parameters, the second set being different from the first set; and
operating the LDS with the second set of parameter values, the operating comprising (i) emitting light by the laser source, and (ii) processing light received by the sensor to obtain the signal;
wherein at least one of the first and second sets is obtained using the prior measurement data.

13. The LDS of claim 12 wherein:
the prior measurement data comprise information on user settings in prior measurements; and
said at least one of the first and second sets is obtained using only those prior measurement data that correspond to prior measurements performed with the same user settings as current user settings.

14. The LDS of claim 13 wherein the current user settings comprise an indication of how large the distance to be measured is.

15. The LDS of claim 13 wherein the current user settings specify whether the measuring is to be performed indoors or outdoors.

16. The LDS of claim 13 wherein the user settings specify whether the distance to be measured is the distance to a spinning object.

17. The LDS of claim 12 wherein at least one parameter value in at least one of the first and second sets affects a power of the light emitted by the LDS.

18. The LDS of claim 12 wherein at least one parameter value in at least one of the first and second sets affects a gain in processing the light received by the LDS.

19. The LDS of claim 12 wherein the signal comprises an electrical signal.

20. The LDS of claim 12 wherein the signal comprises an optical signal.
